(19) United States
(12) Patent Application Publication
(10) Pub. No.: US 2007/0114874 A1
(43) Pub. Date: May 24, 2007

(54) Motor having a stator and a rotor made of soft magnetic powder material

(75) Inventor: Jin-Kwan Ku, Seoul (KR)

Correspondence Address: BACON & THOMAS, PLLC, 625 SLATERS LANE, FOURTH FLOOR, ALEXANDRIA, VA, 22314, US

(73) Assignee: DAEWOO ELECTRONICS CORPORATION, Seoul (KR)

(21) Appl. No.: 11/602,946

(22) Filed: Nov. 22, 2006

(30) Foreign Application Priority Data
Nov. 23, 2005 (KR) 10-2005-0112295
Nov. 23, 2005 (KR) 10-2005-0112296

(51) Int. Cl. H02K 15/12; H02K 1/00; H02K 1/06

(52) U.S. Cl. 310/217; 310/45; 310/216; 417/423.7

(57) ABSTRACT

A stator includes a stator body and a plurality of compression beads formed on an outer surface of the stator body to reduce a contact surface between the stator body and an inner surface of the shell, the plurality of compression beads being compressed by the inner surface of the shell and thus held therein when the stator is fitted into the shell. Further, the plurality of compression beads is oriented in a direction in which the stator body is fitted into the shell, and each of the plurality of compression beads has an inclined guide part on an end corresponding to an end of the stator body that is first fitted into the shell, to guide the fitting of the stator body.

### FIELD OF THE INVENTION

The present invention relates generally to a motor having a stator and a rotor made of soft magnetic powder, and, more particularly, to a motor having a stator and rotor, which are made of soft magnetic powder so that the stator and the rotor can be smoothly and force-fitted into a shell of the motor without being physically damaged during a motor assembly process.

### BACKGROUND OF THE INVENTION

As well known to those skilled in the art, motors are devices which convert electric energy into mechanical energy to provide rotating force. The motors are widely used in industrial apparatuses as well as in domestic electronic products. As examples of domestic electronic products in which the motors are used, there are washing machines, cleaners, optical disk players, hard disk-drives of computers, and compressors, which are provided in air cooling devices, such as air-conditioners and refrigerators, to condense refrigerants into liquid states.

A conventional representative motor will be explained herein below with reference to the attached drawing.

FIG. 1 is a sectional view showing a motor according to a conventional technique. As shown in the drawing, the conventional motor 10 is provided at a predetermined position in a compressor 1 of a refrigerator and includes a shell 11, a stator 12 fixed to the inner surface of the shell 11, a rotor 13, which is rotatably provided in the stator 12, and a rotating shaft 14, which is firmly fitted into the rotor 13.

The shell 11 is closed at opposite ends thereof by an upper cover 11a and a lower cover 11b, thus defining a space for installation of the stator 12 and the rotor 13 therein.

The stator 12 is manufactured from layered silicon steel plates. A coil 12a is wound around the stator 12.

The rotor 13 is manufactured by layering thin silicon steel plates, each of which has a ring shape, thus forming a cylindrical shape. Furthermore, an upper ring 13a and a lower ring 13b are respectively provided on the upper end and under the lower end of the rotor 13. A balance weight 13c, which prevents vibration due to weight imbalance during the rotation of the rotor 13, is coupled at a predetermined position to the lower ring 13b.

The rotating shaft 14 is firmly fitted into the rotor 13 along the rotating center axis of the rotor 13.

In the conventional motor 10 having the above-mentioned construction, when the motor 10 is operated, the rotating shaft 14, which is rotated along with the rotor 13, provides rotating force to a compressing unit 20 of the compressor 1, which compresses refrigerant, which is drawn thereinto from the outside through an inlet 31 after passing through an accumulator 30, and which discharges it through an outlet (not shown). As such, to condense refrigerant in the refrigerator into a liquid state, the motor 10 generates a relatively large torque, sufficient to ensure superior compressing ability, and is rotated at a relatively high speed.

However, in the conventional motor 10, because the stator 12 is made of layered silicon steel plates, when the stator 12 is force-fitted into the shell 11, a portion of the stator 12 at which stress is concentrated may be physically damaged by torsion, for example, the layered silicon steel plates may be separated from each other or may be bent. Consequently, this makes insertion of the stator 12 into the shell 11 difficult. In the same manner, because the rotor 13 is also made of layered silicon steel plates, when the rotating shaft 14 is force-fitted into the rotor 13, the portion of the rotor 13 at which stress is concentrated may be physically damaged by torsion, for example, the layered silicon steel plates may be separated from each other or bent. In addition, this makes insertion of the rotating shaft 14 into the rotor 13 difficult.

Therefore, to fit the stator 12 into the shell 11, the shell 11 is heated to 200° C. to 230° C. such that it is thermally expanded somewhat. Thereafter, the stator 12 is fitted into the shell 11, the diameter of which has been increased. To fit the rotating shaft 14 into the rotor 13, the rotor 13 is also heated at 200° C. to 230° C. such that it is thermally expanded somewhat. Thereafter, the rotating shaft 14 is fitted into the rotor 13, which has been increased in diameter.

However, in the case where the motor 10 is assembled through the above-mentioned heat-shrink fitting process, the assembly process is complicated, and a separate apparatus for heat-shrink fitting is required. Hence, there are problems in that the productivity is reduced and the cost of manufacturing the motor 10 is increased.

Although the above-mentioned problems have been illustrated as being caused in the motor 10 provided in the compressor 1 of the refrigerator, the problems are not limited thereto, but are caused in any motor which is manufactured through a heat-shrink fitting process.

Therefore, the development of a stator and rotor for motors, which can be assembled through a simple force-fitting process and do not cause physical damage during the force-fitting process, is required.

### SUMMARY OF THE INVENTION

Accordingly, the present invention has been made keeping in mind the above problems occurring in the prior art, and an object of the present invention is to provide a stator for a motor which is made of soft magnetic powder material so that, when a motor assembly process is conducted, the stator can be easily assembled with a shell of the motor through a force-fitting process without causing physical damage upon force-fitting, thus the motor assembly process is simplified, thereby increasing productivity and reducing the cost of manufacturing the motor.

Another object of the present invention is to provide a rotor for a motor which is made of soft magnetic powder material so that, when a motor assembly process is conducted, the rotating shaft of the motor can be easily assembled with the rotor through a force-fitting process without physical damage caused by force-fitting, thus the motor assembly process is simplified, thereby increasing productivity and reducing the cost of manufacturing the motor.

In an aspect, the present invention provides a stator for a motor which is adapted to be fitted into a shell of the motor and is made of compressed soft magnetic powder. The stator includes a stator body, and a plurality of compression beads, which are formed on an outer surface of the stator body to reduce a contact surface between the stator body and an inner surface of the shell. The compression beads are compressed by the inner surface of the shell and thus held therein when the stator is fitted into the shell.

In another aspect, the present invention provides a rotor for a motor into which a rotating shaft of the motor is fitted, and which is made of compressed soft magnetic powder. The rotor includes a rotor body, which has in a central portion thereof a fastening part, into which the rotating shaft is fitted, and a plurality of compression beads, which are formed on an inner surface of the fastening part of the rotor body to reduce a contact surface between the fastening part and the rotating shaft and are compressed by the rotating shaft.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a sectional view showing a motor according to a conventional technique;

FIGS. 2A and 2B are sectional views of a motor having a stator made of soft magnetic powder material, according to the present invention;

FIG. 3 is a sectional view taken along line A-A′ of FIG. 2A;

FIGS. 4A to 4C are sectional views of a motor having a rotor made of soft magnetic powder material, according to the present invention; and

FIG. 5 is a sectional view taken along line A-A′ of FIG. 4A.

### DETAILED DESCRIPTION OF THE PREFERRED EMBODIMENT

Hereinafter, preferred embodiments of the present invention will be described in detail with reference to the attached drawings, such that those skilled in the art can easily implement the present invention.

### FIRST EMBODIMENT

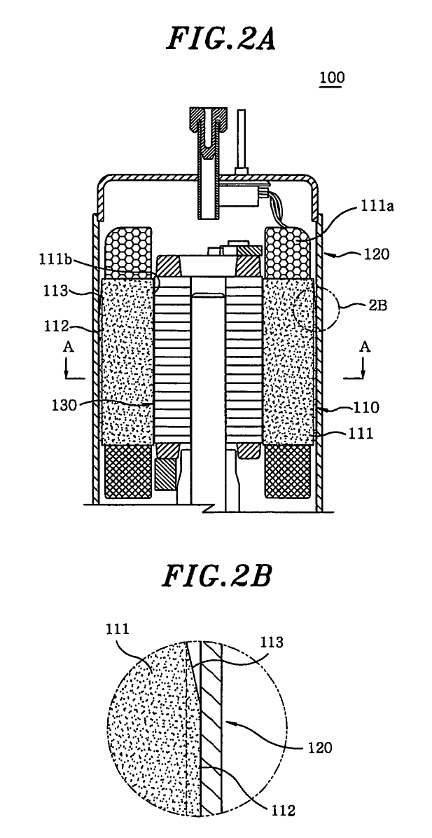

FIGS. 2A and 2B are sectional views of a motor 100 having a stator 110 made of soft magnetic powder material, according to the present invention. As shown in the drawing, the stator 110 made of soft magnetic powder material according to the present invention includes a stator body 111 and a plurality of compression beads 112, which are formed on the outer surface of the stator body 111. The stator 110 is formed by compressing soft magnetic powder.

The stator body 111 is fastened to the inner surface of a shell 120 of the motor 100. A coil 111a is wound around the stator body 111, and a through hole 111b is longitudinally formed through the stator body 111 so that a rotor 130 fitted over a rotating shaft 131 is rotatably installed in the through hole 111b. Furthermore, the stator body 111 has a cross-section, which has a circular or polygonal shape or the shape of a figure comprising a curved line and a straight line. Several compression beads 112 are formed on the outer surface of the stator body 111.

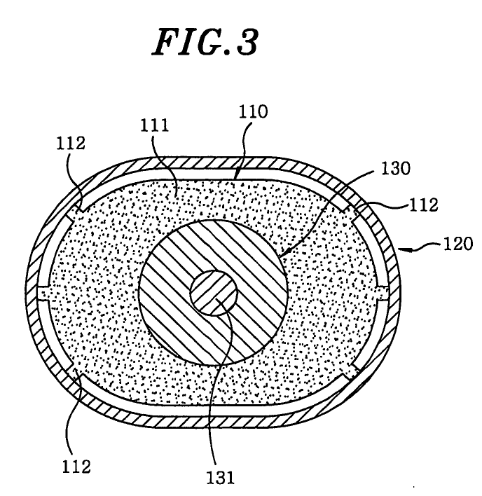

Preferably, as shown in FIG. 3, the several compression beads 112 are formed on the outer surface of the stator body 111 at positions spaced apart from each other by predetermined intervals. The compression beads 112 serve to reduce the contact area between the outer surface of the stator body 111 and the inner surface of the shell 120 such that the stator body 111 can be smoothly force-fitted into the shell 120. When the stator body 111 is force-fitted into the shell 120, the compression beads 112 are compressed by the inner surface of the shell 120, so that the stator body 111 is reliably fastened to the inner surface of the shell 120.

The compression beads 112 are formed on the outer surface of the stator body 111 in the longitudinal direction of the stator body 111, that is, in the direction in which the stator body 111 is inserted into the shell 120, such that the stator body 111 can be easily force-fitted into the shell 120. Furthermore, each compression bead 112 has a guide part 113 on the end corresponding to the end of the stator body 111 that is first inserted into the shell 120.

The guide parts 113 have inclined shapes such that the compression beads 112 smoothly compress the inner surface of the shell 120 when the stator body 111 is fitted into the shell 120, thus serving to guide forcible insertion of the stator body 111 into the shell 120.

The stator 110 of the present invention is made of compressed soft magnetic powder. The soft magnetic powder mainly comprises iron-based grains. Each grain of the soft magnetic powder is coated with predetermined material for electrical insulation.

To form the stator 110 using soft magnetic powder through a compression molding process, a compression molding machine, in which a molding cavity having a shape corresponding to the stator 110 is defined, is provided. Thereafter, soft magnetic powder is charged into the molding cavity and is compressed by a compressing unit such as a press, thus being manufactured into the shape of the stator body 111 having the compression beads 112. Here, a lubricant and/or binder may be added to the soft magnetic powder before the compressing process is conducted.

As such, the stator 110 comprises a soft magnetic composite (SMC), which has a three-dimensional shape and is manufactured through the process of compressing soft magnetic powder. Therefore, a degree of freedom higher than the conventional art, which uses silicon steel plates, is possible.

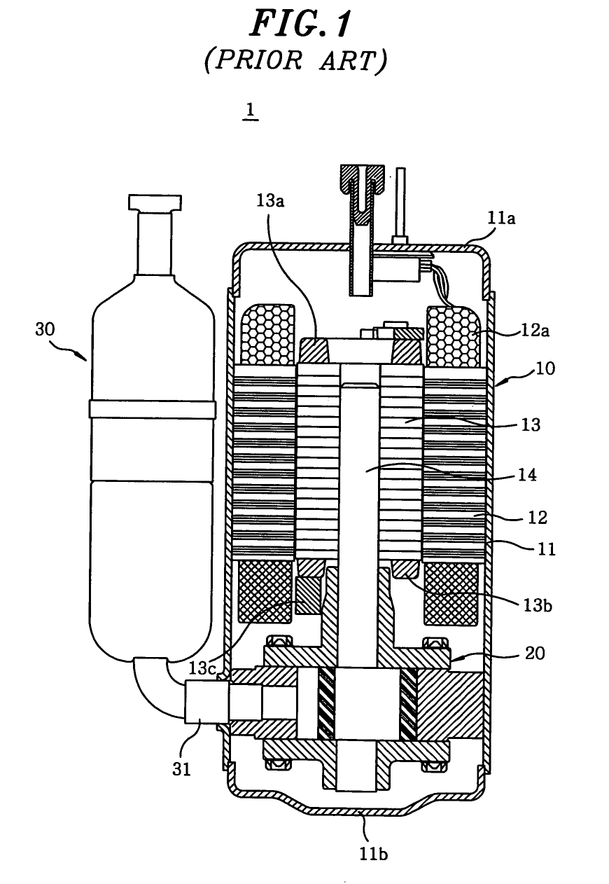

Meanwhile, in this embodiment, the motor 100 provided in the compressor 1 (see, FIG. 1) of a refrigerator has been illustrated as a representative example, but the present invention is not limited to this. That is, the present invention can be applied to any motor in which a stator is force-fitted into a shell.

The operation of the stator, which has the above-mentioned structure and is manufactured using soft magnetic powder material, will be described herein below.

The stator 110 of the present invention can be force-fitted into the shell by the compression beads 112, which contact the inner surface of the shell 120 to reduce the contact area between the stator 110 and the inner surface of the shell 120. Therefore, in the installation of the stator 110 in the shell 120, the present invention does not require a heat-shrink fitting process and equipment for heat-shrink fitting, unlike the conventional art.

Furthermore, when the stator 110 is force-fitted into the shell 120, because the several compression beads 112 are compressed by the inner surface of the shell 120, the stator 110 can be firmly fastened to the inner surface of the shell 120. Particularly, the compression beads 112 are oriented in the longitudinal direction of the stator body 111, that is, in the direction in which the stator 110 is inserted into the shell 120. Thus, the stator body 111 is reliably prevented from being undesirably rotated with respect to the shell 120.

As well, because the stator 110 comprises an SMC, even though it is force-fitted into the shell 120, a problem with the conventional layered silicon steel plate structure, in which portions of the layered silicon steel plates are damaged by torsion caused by stress concentration, is avoided. Furthermore, because the stator 110 comprises the SMC, it is possible to include the compression beads 112, which cannot be formed in the conventional layered silicon steel plate structure.

In addition, because the guide parts 113 are provided on the respective compression beads 112 of the stator 110, the stator 110 can be smoothly inserted into the shell 120 without requiring excessive force at an initial stage of the process of force-fitting the stator 110 into the shell 120.

As described above, in the first embodiment of the present invention, the stator 110 made of soft magnetic powder material can be provided with the compression beads 112 having the guide parts 113, unlike the conventional structure, in which silicon steel plates having the same shape are layered, so that the stator 110 can be smoothly and force-fitted into the shell 120 without damaging the shell 120 during the process of assembling the motor 100, thus increasing productivity and reducing the cost of manufacturing the motor 100.

### SECOND EMBODIMENT

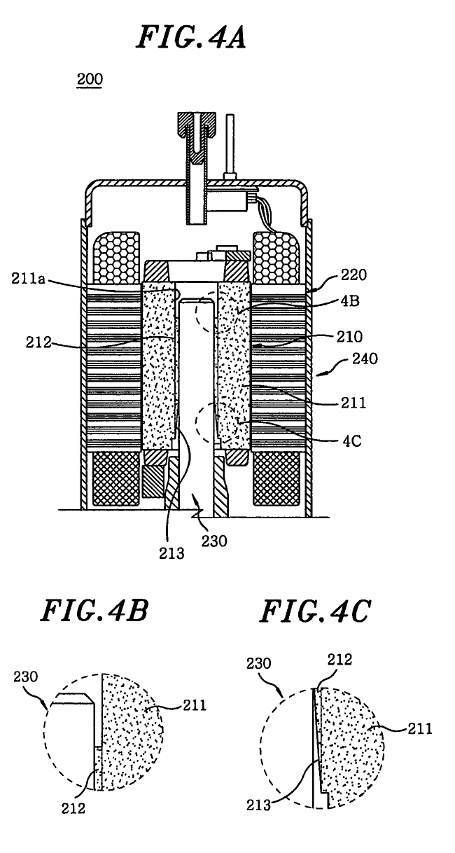

FIGS. 4A to 4C are sectional views of a motor 200 having a rotor 210 made of soft magnetic powder material, according to the present invention. As shown in the drawing, the rotor 210 made of soft magnetic powder material includes a rotor body 211, and a plurality of compression beads 212, which are provided on the inner surface of the rotor body 211. The rotor 210 is formed by compressing soft magnetic powder.

The rotor body 211 is rotatably provided in a stator 220 installed in a shell 240 of the motor 200. The rotor body 211 is cylindrical and has in a central portion thereof a fastening part 211a, into which a rotating shaft 230 is force-fitted.

In the case of the conventional art, in which a rotor body is manufactured by layering a plurality of silicon steel plates, a fastening part must be formed into a simple hole shape. However, in the present invention, because the rotor body 211 is made of compressed soft magnetic powder, it is not limited to any particularly shape. Furthermore, the hole defining the fastening part 211a may be closed at one end thereof. The compression beads 212 are formed on the inner surface of the fastening part 211a.

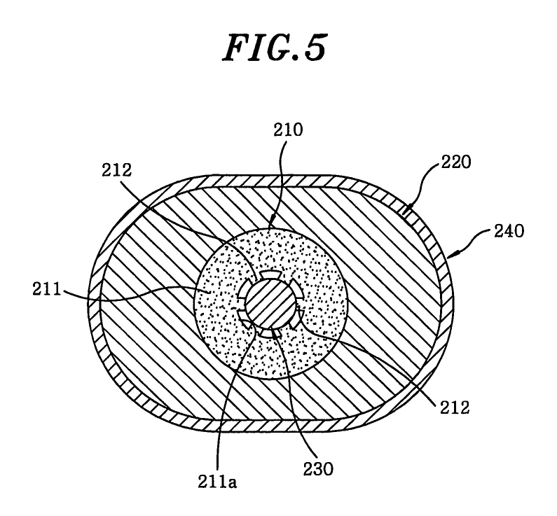

Preferably, as shown in FIG. 5, the compression beads 212 are formed on the inner surface of the fastening part 211a of the rotor body 211 at positions spaced apart from each other by predetermined intervals.

The compression beads 212 serve to reduce the contact area between the inner surface of the fastening part 211a and the outer surface of the rotating shaft 230, such that the rotating shaft 230 can be smoothly force-fitted into the fastening part 211a. When the rotating shaft 230 is force-fitted into the fastening part 211a, the compression beads 212 are compressed by the outer surface of the rotating shaft 230, so that the rotating shaft 230 can be reliably fastened to the fastening part 211a.

The compression beads 212 are oriented in the direction in which the fastening part 211a is formed, that is, in the direction in which the rotating shaft 230 is inserted into the fastening part 211a, such that the rotating shaft 230 can be easily force-fitted into the fastening part 211a. Furthermore, each compression bead 212 has a guide part 213 on an end corresponding to the end of the fastening part 211a into which the rotating shaft 230 is inserted.

The guide parts 213 have inclined shapes such that the compression beads 212 smoothly compress the outer surface of the rotating shaft 230 when the rotating shaft 230 is fitted into the fastening part 211a, thus serving to guide forcible insertion of the rotating shaft 230 into the fastening part 211a.

The rotor 210 of the present invention is made of compressed soft magnetic powder. The soft magnetic powder mainly comprises iron-based grains. Each grain of the soft magnetic powder is coated with predetermined material for electrical insulation.

To form the rotor 210 using soft magnetic powder through a compression molding process, a compression molding machine, in which a molding cavity having a shape corresponding to the rotor 210 is defined, is provided. Thereafter, soft magnetic powder is charged into the molding cavity and is compressed by a compressing unit such as a press, thus being formed into the shape of the rotor body 211, the fastening part 211a of which has the compression beads 212. Here, a lubricant and/or binder may be added to the soft magnetic powder before the compressing process is conducted.

As such, the rotor 210 comprises a soft magnetic composite (SMC), which has a three-dimensional shape and is manufactured through the process of compressing soft magnetic powder. Therefore, a degree of freedom higher than the conventional art, which uses silicon steel plates, is possible.

Although, in this embodiment, the motor 200 provided in the compressor 1 (see, FIG. 1) of a refrigerator has been illustrated as a representative example, the present invention is not limited to this. That is, the present invention can be applied to any motor in which a rotating shaft is force-fitted into a rotor.

The operation of the rotor, which has the above-mentioned structure and is manufactured using soft magnetic powder material, will be described herein below.

In the rotor 210 of the present invention, the rotating shaft 230 can be force-fitted into the fastening part 211a of the rotor 210 by the compression beads 212, which contact the outer surface of the rotating shaft 230 to reduce the substantial contact area between the fastening part 211a and the rotating shaft 230. Therefore, in the coupling process between the rotor 210 and the rotating shaft 230, the present invention does not require a heat-shrink fitting process or equipment for heat-shrink fitting, unlike the conventional art.

Furthermore, when the rotating shaft 230 is force-fitted into the fastening part 211a of the rotor 210, because the several compression beads 212 are compressed by the outer surface of the rotating shaft 230, the rotating shaft 230 can be firmly fastened to the fastening part 211a. Particularly, the compression beads 212 are formed on the fastening part 211a in the longitudinal direction of the rotor body 211, that is, in the direction in which the rotating shaft 230 is inserted into the fastening part 211a. Thus, the rotating shaft 230 is reliably prevented from being undesirably rotated with respect to the fastening part 211a.

As well, because the rotor 210 comprises an SMC, even though the rotating shaft 230 is force-fitted into the fastening part 211a, a problem with conventional layered silicon steel plate structure, in which portions of the layered silicon steel plates are damaged by torsion caused by stress concentration, is avoided. Furthermore, the rotor 210, which comprises the SMC, makes it possible to have the compression beads 212 which cannot be formed in the conventional layered silicon steel plate structure.

In addition, because the guide parts 213 are provided on the respective compression beads 212 of the rotor 210, the rotating shaft 230 can be smoothly inserted into the fastening part 211a without requiring excessive force at an initial stage of the process of force-fitting the rotating shaft 230 into the fastening part 211a.

As such, in the second embodiment of the present invention, the rotor 210 made of soft magnetic powder material can be provided with the compression beads 212 having the guide parts 213, unlike the conventional structure, such that silicon steel plates having the same shape are layered, so that the rotating shaft 230 can be smoothly force-fitted into the rotor 210 without physical damage during the process of assembling the motor 200, thus increasing the productivity, and reducing the cost of manufacturing the motor 200.

As described above, the present invention provides a stator and rotor for a motor which are made of soft magnetic powder material so that a force-fitting process can be smoothly conducted without physical damage during a process of assembling a motor, thus the motor assembly process is simplified, thereby increasing productivity and reducing the cost of manufacturing the motor.

Although the preferred embodiments of the stator and motor for motors made of soft magnetic powder material have been disclosed, these are only illustrative examples. The present invention is not limited to the preferred embodiments. Those skilled in the art will appreciate that various modifications, additions and substitutions are possible, without departing from the scope and spirit of the invention as disclosed in the accompanying claims.

What is claimed is:

1. A stator for a motor which is adapted to be fitted into a shell of the motor and is made of compressed soft magnetic powder, the stator comprising:
a stator body; and
a plurality of compression beads formed on an outer surface of the stator body to reduce a contact surface between the stator body and an inner surface of the shell, the plurality of compression beads being compressed by the inner surface of the shell and thus held therein when the stator is fitted into the shell.

2. The stator as set forth in claim 1, wherein the plurality of compression beads is oriented in a direction in which the stator body is fitted into the shell, and each of the plurality of compression beads has an inclined guide part on an end corresponding to an end of the stator body that is first fitted into the shell, to guide the fitting of the stator body.

3. A rotor for a motor into which a rotating shaft of the motor is fitted, and which is made of compressed soft magnetic powder, the rotor comprising:
a rotor body having in a central portion thereof a fastening part, into which the rotating shaft is fitted; and
a plurality of compression beads formed on an inner surface of the fastening part of the rotor body to reduce a contact surface between the fastening part and the rotating shaft, the plurality of compression beads being compressed by the rotating shaft.

4. The rotor as set forth in claim 3, wherein the plurality of compression beads is oriented in a direction in which the rotating shaft is fitted into the fastening part of the rotor body, and each of the plurality of compression beads has an inclined guide part on an end corresponding to an end of the fastening part into which the rotating shaft is fitted, to guide the fitting of the rotating shaft.

5. A motor, having a stator fitted into a shell thereof, and a rotor, into which a rotating shaft is fitted, wherein the stator is made of compressed soft magnetic powder and comprises a stator body, and a plurality of compression beads formed on an outer surface of the stator body to reduce a contact surface between the stator body and an inner surface of the shell, the plurality of compression beads being compressed by the inner surface of the shell.

6. A motor, having a stator fitted into a shell thereof, and a rotor, into which a rotating shaft is fitted, wherein the rotor is made of compressed soft magnetic powder and comprises a rotor body having in a central portion thereof a fastening part, into which the rotating shaft is fitted, and a plurality of compression beads formed on an inner surface of the fastening part of the rotor body to reduce a contact surface between the fastening part and the rotating shaft, the plurality of compression beads being compressed by the rotating shaft.
